(19) United States
(12) Patent Application Publication
(10) Pub. No.: US 2025/0174891 A1
(43) Pub. Date: May 29, 2025

(54) TRANSMITARRY ANTENNA CELL

(71) Applicant: Commissariat à l'Energie Atomique et aux Energies Alternatives, PARIS (FR)

(72) Inventors: Antonio CLEMENTE, GRENOBLE (FR); José-Luis GONZALEZ JIMENEZ, GRENOBLE (FR); Luca LUCCI, GRENOBLE (FR)

(21) Appl. No.: 18/959,886

(22) Filed: Nov. 26, 2024

(30) Foreign Application Priority Data
Nov. 27, 2023 (FR) 2313128

(51) Int. Cl. H01Q 3/34; H01Q 1/22; H01Q 21/24

(52) U.S. Cl. CPC H01Q 3/34; H01Q 1/2283; H01Q 21/24

(57) ABSTRACT

The present description concerns a transmitarray antenna cell (105) comprising a semiconductor substrate (201); a first rectilinear polarizer (207a), located on the side of a first surface (201a) of the semiconductor substrate; a second rectilinear polarizer (207b), located on the side of a second surface (201b) of the semiconductor substrate opposite to the first surface and orthogonal to the first polarizer; and at least one radiating element (203-1, 203-2 interposed between the second surface (201b) of the semiconductor substrate and the second polarizer (207b), said at least one radiating element being adapted to switching between at least two phase states.

### FIELD

The present disclosure generally concerns electronic devices. The present disclosure in particular aims at radio antennas, more specifically transmitarray antennas.

### BACKGROUND

In various applications, such as satellite communication systems and devices for communication over 5G and 6G mobile networks, it is desirable to have electronically steerable radio antennas. As an example, a sweep range of at least 120° is often required for an antenna integrated in a mobile satellite communication terminal in order to ensure an effective communication between the terminal and the satellite. Similar specifications will be required for antennas in a 6G access point at sub-THz frequencies, that is, frequencies from 100 to 500 GHz.

Among the different radio antenna technologies likely to meet the needs of applications using sub-THz frequencies, phased-array antennas, and reconfigurable liquid crystal metasurfaces have been provided. Phased-array antennas have the advantage of allowing a precise control of the steering of the beam emitted by the antenna, and of providing access to a wide angular range. Liquid crystal reconfigurable metasurfaces have a higher compactness than phased-array antennas, while offering similar advantages. However, phased-array antennas have power consumptions and production costs too high for an integration in consumer devices, and reconfigurable metasurfaces suffer from excessive losses and a relatively low bandwidth.

Transmitarray antennas and reflectarray antennas have further been provided. Transmitarray antennas typically comprise a plurality of elementary cells, each comprising a first antenna element irradiated by an electromagnetic field emitted by one or a plurality of focal sources, a second antenna element transmitting a modified signal to the outside of the antenna, and a coupling element interposed between the first and second antenna elements. Reflectarray antennas typically comprise a plurality of elementary cells, each comprising an antenna element irradiated by an electromagnetic field emitted by one or a plurality of sources, a reflector element, for example a ground plane, reflecting a modified signal towards the outside of the antenna, and a coupling element between the antenna element and the reflector element. Transmitarray or reflectarray antennas, for example, are formed on a CMOS (Complementary Metal-Oxide-Semiconductor) substrate. Further, each elementary cell of a reconfigurable transmitarray or reflectarray antenna comprises for example at least one switch, for example a switch based on a phase-change material. Transmitarray or reflectarray antennas have the advantage of having, as compared with phased-array antennas and reconfigurable metasurfaces, a higher efficiency and lower production costs. However, existing transmitarray or reflectarray antennas suffer from various disadvantages, such as high transmission losses, too narrow transmit and/or receive bands, a high design complexity, etc.

### SUMMARY

There exists a need to overcome all or part of the disadvantages of existing transmitarray antennas. In particular, it would be desirable to have transmitarray antennas having a high gain, a high energy efficiency, and a decreased complexity.

For this purpose, an embodiment provides a transmitarray antenna cell comprising:
a semiconductor substrate;
a first rectilinear polarizer, located on the side of a first surface of the semiconductor substrate;
a second rectilinear polarizer, located on the side of a second surface of the semiconductor substrate opposite to the first surface and orthogonal to the first polarizer; and
at least one radiating element interposed between the second surface of the semiconductor substrate and the second polarizer, said at least one radiating element being adapted to switching between at least two phase states.

According to an embodiment, each radiating element comprises at least two parts coupled by a switch formed in the semiconductor substrate.

According to an embodiment, said at least one radiating element comprises exactly first and second parts each having, in top view, a T-shape.

According to an embodiment, the cell comprises exactly first and second radiating elements forming, in top view, a cross having a first arm comprising the first and second parts of the first radiating element, and a second arm, substantially orthogonal to the first arm, comprising the first and second parts of the second radiating element.

According to an embodiment, the top bar of the T formed by each part of each radiating element has an adjustable length.

According to an embodiment, each radiating element is located on top of and in contact with the second surface of the semiconductor substrate.

According to an embodiment:
the first polarizer comprises a plurality of first conductive strips substantially parallel to one another; and—the second polarizer comprises a plurality of second conductive strips substantially parallel to one another and substantially orthogonal to the first conductive strips.

According to an embodiment, the cell further comprises:
a first insulating region interposed between the first surface of the semiconductor substrate and the first polarizer; and
a second insulating region interposed between the second surface of the semiconductor substrate and the second polarizer.

According to an embodiment, the first and second insulating regions form part of insulating layers of a printed circuit board, each radiating element and the first and second polarizers being formed in metallization levels of the printed circuit board.

According to an embodiment, the radiating element(s) are formed in at least one metallization level of an interconnection stack interposed between the semiconductor substrate and the second polarizer.

An embodiment provides a transmitarray comprising a plurality of cells such as described.

According to an embodiment, the semiconductor substrate is common to a plurality of cells in the array.

An embodiment provides an antenna comprising a transmittarray such as described and at least one source configured to irradiate a surface of the array.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 is a side view, simplified and partial, of an example of a transmitarray antenna of the type to which, as an example, described embodiments apply;

FIG. 2 is a side and cross-section view, simplified and partial, of a transmitarray antenna cell according to an embodiment;

FIG. 3A, FIG. 3B, and FIG. 3C are top views, simplified and partial, of the cell of FIG. 2;

FIG. 4 is a top view, simplified and partial, of a variant of a radiating element of the cell of FIG. 2; and

FIG. 5 is a side and cross-section view, simplified and partial, of a transmitarray of a radio antenna according to an embodiment.

### DETAILED DESCRIPTION OF THE PRESENT EMBODIMENTS

The same elements have been designated by the same references in the various figures. Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail. In particular, embodiments of a transmitarray antenna cell are described hereafter. The structure and the operation of the primary source(s) of the antenna intended to irradiate the transmitarray will however not be detailed, the described embodiments being compatible with all or most known primary irradiation sources for transmitarray antennas. As an example, each primary source is adapted to producing a beam of generally conical shape irradiating all or part of the transmitarray. Each primary source comprises, for example, a horn antenna. As an example, the central axis of each primary source is substantially orthogonal to the mean plane of the array.

Further, the methods of manufacturing the described transmitarrays will not be detailed, the forming of the described structures being within the abilities of those skilled in the art based on the indications of the present disclosure, for example by implementing conventional printed circuit board manufacturing techniques.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

In the following description, the qualifiers “insulating” and “conductive” respectively signify, unless otherwise specified, electrically insulating and electrically conductive.

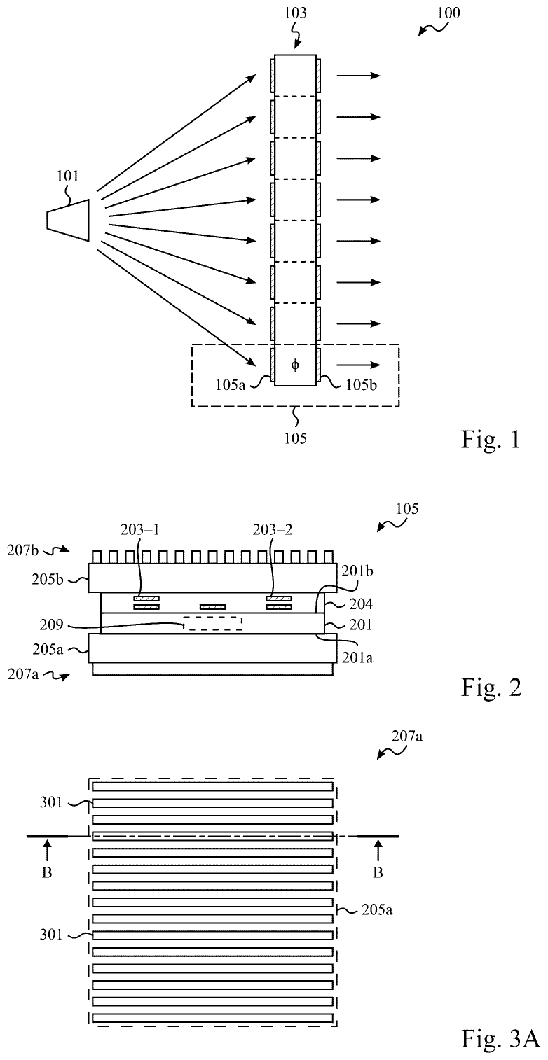

FIG. 1 is a side view, simplified and partial, of an example of a transmitarray antenna 100 of the type to which apply, as an example, described embodiments.

Antenna 100 typically comprises one or a plurality of primary sources 101 (a single source 101, in the shown example) irradiating a transmitarray 103. Source 101 may have any polarization, for example linear or circular. Array 103 comprises a plurality of elementary cells 105, for example arranged in an array of rows and columns. Each cell 105 typically comprises a first antenna element 105a, located on the side of a first surface of array 103 arranged in front of primary source 101, and a second antenna element 105b, located on the side of a second surface of the array opposite to the first surface. The second surface of array 103 for example faces a transmitting medium of antenna 100.

Each cell 105 is capable, in transmit mode, of receiving an electromagnetic radiation on its first antenna element 105a and of retransmitting this radiation from its second antenna element 105b, for example by introducing a known phase shift ϕ. In receive mode, each cell 105 is capable of receiving an electromagnetic radiation on its second antenna element 105b and of retransmitting this radiation from its first antenna element 105a with the same phase shift ϕ.

The characteristics of the beam generated by antenna 100, in particular its shape (or pattern) and its maximum emission direction (or pointing direction), depend on the values of the phase shifts respectively introduced by the various cells 105 of array 103. An amplitude control may further be exerted, by each elementary cell, on the incident electromagnetic wave.

Transmitarray antennas have the advantages, among others, of having a good energy efficiency and of being relatively simple, inexpensive, and of low bulk. This is in particularly due to the fact that transmitarrays may be formed in planar technology, generally on printed circuit boards.

The present disclosure more particularly aims at reconfigurable transmitarray antennas 103. Transmitarray 103 is said to be reconfigurable when elementary cells 105 are electronically controllable, individually, to modify their phase-shift value ϕ. This enables to dynamically modify the characteristics of the beam generated by the antenna, and in particular to modify its pointing direction without mechanically moving the antenna or part of the antenna by means of a motorized element.

FIG. 2 is a side and cross-section view, simplified and partial, of a transmitarray antenna cell according to an embodiment, for example one of the elementary cells 105 of the transmitarray 103 of the antenna 100 described hereabove in relation with FIG. 1.

In the shown example, elementary cell 105 comprises a semiconductor substrate 201. Substrate 201 is, for example, a wafer or a piece of wafer made of a semiconductor material, for example silicon. Semiconductor substrate 201 is, for example, of CMOS (Complementary Metal-Oxide-Semiconductor) type. In this case, substrate 201 comprises one or a plurality of electronic components based on CMOS technology, for example at least one MOS transistor. As a variant, substrate 201 may be made of a semiconductor material different from silicon, for example a III-V semiconductor material such as gallium nitride (GaN) or gallium arsenide (GaAs).

In the illustrated example, elementary cell 105 further comprises radiating elements 203-1 and 203-2 located on semiconductor substrate 201. In this example, radiating elements 203-1 and 203-2 are more precisely formed in an interconnection stack or network 204 located on top of and in contact with a surface 201b of substrate 201 (the upper surface of substrate 201, in the orientation of FIG. 2). In the shown example, interconnection stack 204 comprises a stack of alternating conductive and insulating layers. As an example, the insulating layers are made of silicon oxide (SiO₂), and for example have a thickness in the order of 4 μm. The conductive layers of interconnection stack 204, symbolized by hatched rectangles in FIG. 2, are, for example, metal layers, also called metallization levels. Although this has not been detailed in the drawings, interconnection stack 204 comprises, for example, in addition to the radiating elements 203-1 and 203-2, conductive tracks formed in the conductive layers and conductive vias, for example metal vias, interconnecting conductive tracks located in different conductive layers.

Radiating elements 203-1 and 203-2 are formed in at least one of the conductive layers of interconnection stack 204. In the illustrated example, radiating elements 203-1 and 203-2 are formed in a single metallization level, for example in the upper metallization level, also called last metallization level, that is, the metallization level most distant from semiconductor substrate 201. This example is however not limiting and radiating elements 203-1 and 203-2 may, as a variant, be formed in a metallization level other than the last metallization level and/or in a plurality of metallization levels of stack 204. Further, in the shown example, the upper metallization level is coated with an insulating layer of stack 204. This example is however not limiting, and the upper metallization level may, as a variant, be flush with the upper surface of stack 204.

Radiating elements 203-1 and 203-2 are, for example, of “on-chip antenna” type. The geometry of radiating elements 203-1 and 203-2 will be described in further detail hereafter.

In the illustrated example, elementary cell 105 further comprises insulating regions 205a and 205b located on either side of semiconductor substrate 201. In this example, insulating region 205a coats a surface 201a of semiconductor substrate 201 (the bottom surface of substrate 201, in the orientation of FIG. 2) opposite to surface 201b. Insulating region 205a is for example more precisely located on top of and in contact with the surface 201a of substrate 201.

In the shown example, insulating region 205b is located on substrate 201 and radiating elements 203-1 and 203-2. In this example, insulating region 205b is more specifically located on top of and in contact with the upper face of interconnection stack 204. In the illustrated example where the last metallization level is coated with an insulating layer, insulating region 205b is located on top of and in contact with this insulating layer. In the case where the last metallization level is flush with the upper surface of interconnection stack 204, insulating region 205b is located on top of and in contact with the last metallization level of stack 204.

As an example, substrate 201 and interconnection stack 204 form an integrated circuit chip, for example more specifically a CMOS-type integrated circuit chip.

Insulating regions 205a and 205b are for example each made of a material having a relative dielectric permittivity Er, also called “dielectric constant”, in the range from 2 to 4. Insulating regions 205a and 205b are, for example, formed in one or a plurality of insulating layers of a printed circuit board. As a variant, each insulating region 205a, 205b may be made of quartz, of fused silica, etc. As an example, each insulating region 205a, 205b has a thickness in the range from 100 to 300 μm.

In the shown example, elementary cell 105 further comprises polarizer-type structures 207a and 207b located on either side of semiconductor substrate 201. In this example, polarizer 207a is located on the side of surface 201a of semiconductor substrate 201. In the shown example, polarizer 207a coats a surface of insulating region 205a opposite to semiconductor substrate 201 (the lower surface of insulating region 205a, in the orientation of FIG. 2).

In the shown example, polarizer 207b is located on the side of surface 201b of semiconductor substrate 201. In this example, polarizer 207b coats a surface of insulating region 205b opposite to semiconductor substrate 201 (the upper surface of insulating region 205b, in the orientation of FIG. 2).

As an example, polarizers 207a and 207b respectively form part of the first and second antenna elements 105a and 105b of elementary cell 105. This corresponds, for example, to a case where polarizer 207a is arranged opposite primary source 101 and polarizer 207b faces the external medium, or transmitting medium, of antenna 100. As a variant, polarizers 207a and 207b may respectively form part of the second and first antenna elements 105b and 105a of elementary cell 105. This corresponds, for example, to a case where polarizer 207a faces the external medium, or transmitting medium, of antenna 100 and where polarizer 207b is arranged opposite primary source 101. In any case, the polarizer located on the source side is polarized in the same direction as the source. In practice, the polarization of the wave to be transmitted or to be received is set, and the polarizers are rotated so as to respect this constraint.

In the case where insulating regions 205a and 205b are formed in one or a plurality of insulating layers of a printed circuit board, radiating elements 203-1 and 203-2 and polarizers 205a and 205b are for example formed in metal conductive layers, also called metallization levels, of the printed circuit board.

As will be explained in more detail hereafter, elementary cell 105 is, for example, a reconfigurable cell adapted to switching between at least two phase states. In this case, each radiating element 203-1, 203-2 is for example coupled, or connected, to at least one switch formed in semiconductor substrate 201, for example in a region 209 of substrate 201 symbolized, in FIG. 2, by a rectangle in dotted lines. The switch(es) formed in region 209 are, for example, connected to radiating elements 203-1 and 203-2 by conductive vias and/or conductive tracks of interconnection stack 204. These connections have not been detailed in FIG. 2 to avoid overloading the drawing.

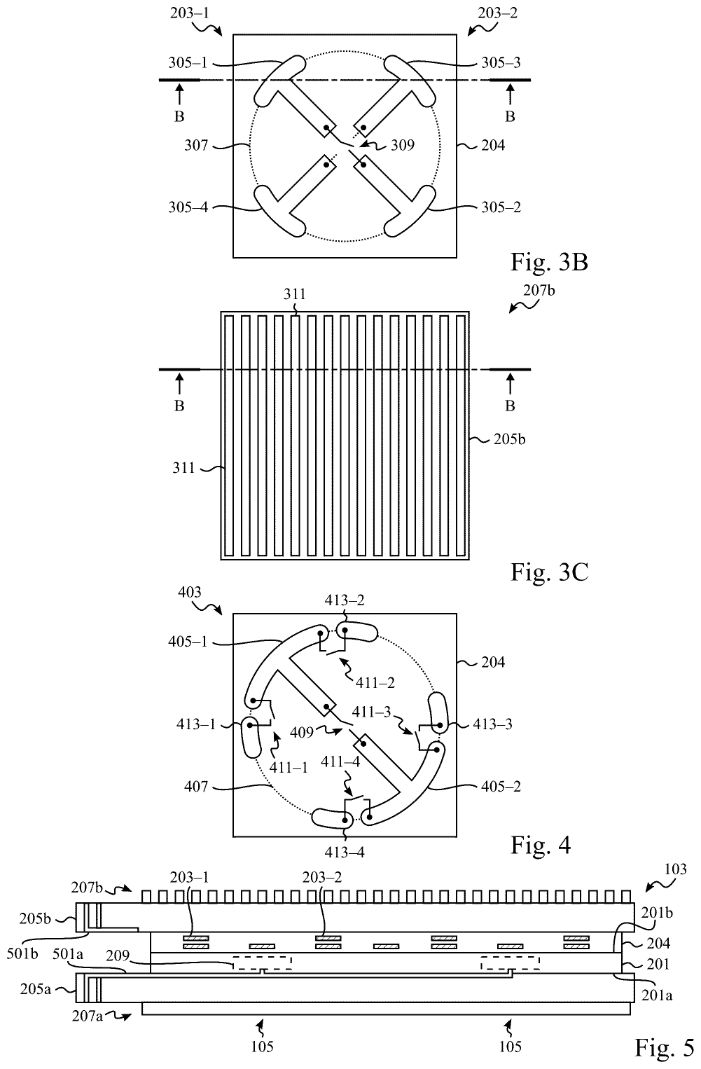

FIG. 3A, FIG. 3B, and FIG. 3C are top views, simplified and partial, of elementary cell 105. FIG. 2 shows a cross-section view of elementary cell 105 along plane BB of FIGS. 3A to 3C.

FIG. 3A more specifically illustrates an example of the structure of polarizer 207a arranged on the side of surface 201a of semiconductor substrate 201.

In the shown example, polarizer 207a comprises a plurality of separate strips 301 located beneath and in contact with insulating region 205a symbolized, in FIG. 3A, by a square in dotted lines. In this example, strips 301 are substantially parallel to one another. In the shown example, strips 301 are substantially regularly spaced apart, with a constant pitch. Strips 301 are for example made of a conductive material, for example a metal such as copper, or a metal alloy.

When antenna 100 operates in transmit mode, polarizer 207a is, in this example, adapted to controlling the transmission, towards radiating elements 203-1 and 203-2, of waves originating from primary source 101. More precisely, polarizer 207a is used to transmit, towards radiating elements 203-1 and 203-2, incident waves having a polarization substantially identical to that of polarizer 207a, that is, a rectilinear polarization substantially orthogonal to strips 301, and to reflect incident waves having a polarization different from that of polarizer 207a, that is, a rectilinear polarization parallel to strips 301.

More precisely, FIG. 3B illustrates an example of the structure of radiating elements 203-1 and 203-2 interposed between surface 201b of semiconductor substrate 201 and polarizer 207b.

In the shown example, radiating elements 203-1 and 203-2 form a cross, a first arm of which comprises two parts 305-1 and 305-2 of radiating element 203-1, and a second arm of which, substantially orthogonal to the first arm, comprises two parts 305-3 and 305-4 of radiating element 203-2. In this example, the parts 305-1, 305-2, 305-3, and 305-4 of radiating elements 203-1 and 203-2 are separate and each have a T-shape. In the shown example, the parts 305-1, 305-2, 305-3, and 305-4 of radiating elements 203-1 and 203-2 have substantially identical dimensions, to within manufacturing dispersions.

In the shown example, the top bars, or horizontal bars, of the Ts formed by the parts 305-1, 305-2, 305-3, and 305-4 of radiating elements 203-1 and 203-2 each have a curved shape. The top bars of the T-shaped elements are, in the example shown in FIG. 3B, arcs of a circle laterally extending, in top view, along the perimeter of a same circle 307. In the shown example, the top bars of the T are evenly distributed along the circumference of circle 307, and each vertical bar of the T intersects the corresponding top bar substantially in its middle. In the shown example, the cross and circle 307 are concentric. In this example, the upper bars of the T are located on the outer side of the cross, and the lower ends of the vertical bars of the T are located on the side of the center of circle 307.

Radiating elements 203-1 and 203-2 are for example made of a conductive material. As an example, radiating elements 203-1 and 203-2 are formed in a metal layer located on top of and in contact with surface 201b of semiconductor substrate 201. The parts 305-1, 305-2, 305-3, and 305-4 of radiating elements 203-1 and 203-2 are for example each made of a metal, for example copper, or of a metal alloy.

In the shown example, the vertical bars of the Ts formed by the parts 305-1 and 305-2 of radiating element 203-1 extend laterally, in top view, along a first diameter of circle 307 forming an angle equal to approximately 45° relative to the strips 301 of polarizer 207a. Similarly, the vertical bars of the T formed by the parts 305-3 and 305-4 of radiating element 203-2 extend laterally, in top view, along a second diameter of circle 307 substantially orthogonal to the first diameter and forming an angle equal to approximately 45° relative to the strips 301 of polarizer 207a.

The parts 305-1, 305-2, 305-3, and 305-4 of radiating elements 203-1 and 203-2 are for example coupled, in pairs of opposite parts, by switches. To avoid overloading the drawing, a single switch 309 coupling the parts 305-1 and 305-2 of radiating element 203-1 has been symbolized in FIG. 3B. In the shown example, switch 309 couples the lower ends of the vertical bars of the T formed by the parts 305-1 and 305-2 of radiating element 203-1. Similarly, another switch, for example similar or identical to switch 309, couples the lower ends of the other parts 305-3 and 305-4 of radiating element 203-2. The switches are for example formed in semiconductor substrate 201, for example in the region 209 previously described in relation with FIG. 2. As an example, switch 309 is a MOS transistor, a varactor, a PIN (Positive Intrinsic Negative) diode, etc. Although this has not been detailed in FIG. 3B, switch 309 has, for example, conduction electrodes respectively connected to the parts 305-1 and 305-2 of radiating element 203-1 by conductive tracks formed in the metallization levels of interconnection stack 204 and/or conductive vias extending vertically across the thickness of interconnection stack 204.

The switch 309 coupling the parts 305-1 and 305-2 of radiating element 203-1 and the switch coupling the parts 305-3 and 305-4 of radiating element 203-2 are, for example, controlled in opposition, one of the switches being controlled to the on state when the other switch is controlled to the off state. Thus, radiating element 203-1 is activated when radiating element 203-2 is deactivated, and vice versa. This enables, for example, elementary cell 105 to switch between two phase states, for example the 0° and 180° states in the case of the structure described in relation with FIGS. 3A to 3C. Elementary cell 105 acts, in this case, as a polarization converter.

Although FIG. 3B illustrates an example in which elementary cell 105 comprises two radiating elements 203-1 and 203-2, this example is not limiting and the elementary cell may, as a variant, comprise a number of radiating elements different from two, for example a single radiating element of generally circular shape comprising a plurality of portions of an arc of a circle coupled to one another by one or a plurality of switches. Generally, each radiating element of elementary cell 105 comprises, for example, at least one pair of diametrically opposite portions coupled by a switch.

Further, although FIG. 3B illustrates a case in which radiating elements 203-1 and 203-2 are formed in a same metallization level of interconnection stack 204, this example is not limiting, and one of radiating elements 203-1 and 203-2 may, as a variant, be formed in a metallization level different from that in which the other radiating element is formed. As an example, the parts 305-1 and 305-2 of radiating element 203-1 are formed in a first metallization level of stack 204, for example the upper metallization level, and the parts 305-3 and 305-4 of radiating element 203-2 are formed in a second metallization level separate from the first metallization level by one of the insulating layers of stack 204, for example a lower metallization level interposed between substrate 201 and the last metallization level.

FIG. 3C shows, in particular an example of the structure of the polarizer 207b arranged on the side of surface 201b of semiconductor substrate 201.

In the shown example, polarizer 207b comprises a plurality of strips 311 located on top of and in contact with insulating region 205b. In this example, strips 311 are substantially parallel to one another. Strips 311 are, for example, substantially orthogonal to the strips 301 of polarizer 207a. In the shown example, strips 311 are substantially regularly spaced apart, at a constant pitch. Strips 311 are for example made of a conductive material, for example of a metal such as copper, or a metal alloy. For purposes of simplification of the manufacturing of elementary cell 105, the strips 311 of polarizer 207b are, for example, made of the same material as the strips 301 of polarizer 207a.

When antenna 100 operates in transmit mode, polarizer 207b is for example adapted to controlling the transmission, to the external medium, of waves originating from radiating elements 203-1 and 203-2. Polarizer 207b more specifically enables to transmit, towards the external medium, incident waves having a polarization substantially identical to that of polarizer 207b, that is, a rectilinear polarization substantially orthogonal to strips 311, and to reflect incident waves having a polarization different from that of polarizer 207b, that is, a rectilinear polarization parallel to strips 311.

FIG. 4 is a top view, simplified and partial, of a variant of the radiating element 203-1 of the elementary cell 105 of FIG. 2. FIG. 4 more specifically illustrates a radiating element 403 likely to be integrated in elementary cell 105, for example as a substitute for the radiating element 203-1 described hereabove in relation with FIG. 3B. In this case, elementary cell 105 comprises, for example, another radiating element similar to radiating element 403, but for example formed in another metallization level of interconnection stack 204 and rotated by approximately 90° with respect to radiating element 403.

In the shown example, radiating element 403 comprises two parts 405-1 and 405-2, for example similar to the parts 305-1 and 305-2 of radiating element 203-1. In this example, each part 405-1, 405-2 of radiating element 403 more specifically comprises a vertical bar laterally extending above the surface 201b of semiconductor substrate 201 along a diameter of a circle 407. In FIG. 4, the parts 405-1 and 405-2 of radiating element 403 are coupled by a switch 409, for example similar or identical to the switch 309 coupling the parts 305-1 and 305-2 of radiating element 203-1. In the illustrated example, each part 405-1, 405-2 of radiating element 403 further comprises a horizontal bar, or top bar, in the shape of an arc of a circle and curved along the circumference of circle 407.

In the orientation of FIG. 4, the left and right ends of the top bar of the T formed by part 405-1 of radiating element 403 are respectively coupled, by switches 411-1 and 411-2, to regions 413-1 and 413-2. In the shown example, regions 413-1 and 413-2 each have the shape of an arc of a circle laterally extending along the circumference of circle 407, in line with the top bar of the T formed by part 405-1 of radiating element 403. Similarly, the left and right ends of the top bar of the T formed by part 405-2 of radiating element 403 are respectively coupled, by switches 411-3 and 411-4, to regions 413-3 and 413-4. In the shown example, regions 413-3 and 413-4 each have the shape of an arc of a circle laterally extending along the circumference of circle 407, in line with the top bar of the T formed by part 405-2 of radiating element 403.

In the shown example, the top bars of the Ts formed by the parts 405-1 and 405-2 of radiating element 403 have an adjustable length. In this example, the control of switches 411-1, 411-2, 411-3, and 411-4 enables to vary the length of the top bars of the Ts formed by the parts 405-1 and 405-2 of radiating element 403. In the shown example, the length of the top bar of the T of part 405-1 of radiating element 403 is increased by the turning on of switches 411-1 and 411-2, and decreased by the turning off of switches 411-1 and 411-2. Switches 411-2 and 411-2 are preferably controlled substantially simultaneously to the off or to the on state. Similarly, the length of the top bar of the T of part 405-2 of radiating element 403 is increased by the turning on of switches 411-3 and 411-4, and decreased by the turning off of switches 411-3 and 411-4. Switches 411-3 and 411-4 are preferably substantially simultaneously controlled to the off or to the on state.

An advantage of radiating element 403 lies in the fact that it advantageously enables to obtain more phase states, and thus a more accurate control of the orientation of the beam emitted by antenna 100, as compared with the case where elementary cell 105 comprises radiating element 203.

Generally, the fact of providing an integer number N greater than or equal to two of switches in elementary cell 105 gives access to a number N−1 of phase quantization bits.

Although FIG. 4 illustrates an example in which each part 405-1, 405-2 of radiating element 403 comprises two regions respectively coupled, by two switches, to the top bar of the T formed by said part, this example is not limiting. As a variant, each part 405-1, 405-2 may comprise an even number greater than two of regions in the shape of an arc of a circle coupled together and to the top bar of the T formed by said part by an even number greater than two of switches. This enables to access even more phase states.

FIG. 5 is a side and cross-section view, simplified and partial, of a transmitarray of a radio antenna, for example the transmitarray 103 of the antenna 100 previously described in relation with FIG. 1, according to an embodiment.

In the shown example, semiconductor substrate 201 and interconnection stack 204 are common to a plurality of elementary cells 105 of transmitarray 103 (two elementary cells 105, in the shown example). In a case where insulating regions 205a and 205b and polarizers 207a and 207b are respectively formed in insulating layers and in metallization levels of a printed circuit board, semiconductor substrate 201 and interconnection stack 204 are for example located in a cavity formed across the thickness of the printed circuit board.

In the shown example, transmitarray 103 comprises contacting elements 501a and 501b enabling to deliver power supply and control voltages to the switches associated with radiating elements 203-1 and 203-2. In the shown example, contacting elements 501a comprise conductive tracks located on top of and in contact with surface 201a of semiconductor substrate 201, conductive vias running across the thickness of insulating region 205a and conductive vias extending across the thickness of substrate 201 from its surface 201a to the regions 209 in which the switches are formed. Similarly, contacting elements 501b comprise conductive tracks extending on top of and in contact with the upper surface of interconnection stack 204 all the way to radiating elements 203-1 and 203-2, and conductive vias extending across the thickness of insulating region 205b. As a variant, the switches of regions 209 may be connected to contacting elements 501b by conductive tracks and conductive vias located in interconnection stack 204.

As an example, semiconductor substrate 201 forms part of an integrated circuit chip mechanically bonded to the printed circuit board comprising insulating regions 205a and 205b and polarizers 207a and 207b by techniques implemented in the surface mounting of electronic components, for example by soldering or via solder balls, for example on the side of region 205a.

Although FIG. 5 illustrates an example in which two elementary cells are formed inside and on top of the same substrate, this example is not limiting. More generally, all or part of the elementary cells 105 of transmitarray 103 may be formed inside and on top of a same substrate. Further, although this has not been shown in FIG. 5, control and power supply circuits may be provided in the printed circuit board. These circuits may, for example, comprise shift registers, flip-flops, buffer circuits, etc. adapted to controlling the switches of elementary cells 105 to the off state or to the on state according to the desired orientation of the beam emitted or received by antenna 100.

As an example, transmitarray 103 may further comprise circuits for controlling and biasing (not shown in FIG. 5) the switches of elementary cells 105. Generally, transmitarray 103 may comprise any number of control and bias circuits associated with any number of elementary cell assemblies, each comprising a plurality of elementary cells formed on a same semiconductor substrate.

Various embodiments and variants have been described. Those skilled in the art will understand that certain features of these various embodiments and variants could be combined, and other variants will become apparent to those skilled in the art. In particular, those skilled in the art are capable of adapting the number of regions 413-1, 413-2, 413-3, and 413-4 as well as the number of switches 411-1, 411-2, 411-3, and 411-4 of radiating element 403 according to the targeted application. Those skilled in the art are further capable of selecting the length of each region 413-1, 413-2, 413-3, and 413-4 according to the desired phase states.

Finally, the practical implementation of the described embodiments and variants is within the abilities of those skilled in the art, based on the functional indications given hereabove. In particular, those skilled in the art are capable of providing integrating in semiconductor substrate 201 electronic components such as power amplifiers, control circuits, a memory, or a processing unit enabling to control the off or on states of the various switches of the radiating elements, etc.

1. Transmitarray antenna cell comprising:
a semiconductor substrate;
a first rectilinear polarizer, located on the side of a first surface of the semiconductor substrate; and
a second rectilinear polarizer, located on the side of a second surface of the semiconductor substrate opposite to the first surface and orthogonal to the first polarizer; and
at least one radiating element interposed between the second surface of the semiconductor substrate and the second polarizer, said at least one radiating element being adapted to switching between at least two phase states.

2. Cell according to claim 1, wherein each radiating element comprises at least two parts coupled by a switch formed in the semiconductor substrate.

3. Cell according to claim 2, wherein said at least one radiating element comprises exactly first and second parts each having, in top view, a T-shape.

4. Cell according to claim 3, comprising exactly first and second radiating elements forming, in top view, a cross having a first arm comprising the first and second parts of the first radiating element, and a second arm, substantially orthogonal to the first arm, comprising the first and second parts of the second radiating element.

5. Cell according to claim 3, wherein the top bar of the T formed by each part of each radiating element has an adjustable length.

6. Cell according to claim 1, wherein each radiating element is located on top of and in contact with the second surface of the semiconductor substrate.

7. Cell according to claim 1, wherein:
the first polarizer comprises a plurality of first conductive strips substantially parallel to one another; and
the second polarizer comprises a plurality of second conductive strips substantially parallel to one another and substantially orthogonal to the first conductive strips.

8. Cell according to claim 1, further comprising:
a first insulating region interposed between the first surface of the semiconductor substrate and the first polarizer; and
a second insulating region interposed between the second surface of the semiconductor substrate and the second polarizer.

9. Cell according to claim 8, wherein the first and second insulating regions form part of insulating layers of a printed circuit board, each radiating element and the first and second polarizers being formed in metallization levels of the printed circuit board.

10. Cell according to claim 1, wherein the radiating element(s) are formed in at least one metallization level of an interconnection stack interposed between the semiconductor substrate and the second polarizer.

11. Transmitarray comprising a plurality of cells according to claim 1.

12. Array according to claim 11, wherein the semiconductor substrate is common to a plurality of cells of the array.

13. Antenna comprising a transmitarray according to claim 11 and at least one source configured to irradiate a surface of the array.
